(19) United States
(12) Patent Application Publication
(10) Pub. No.: US 2011/0294310 A1
(43) Pub. Date: Dec. 1, 2011

(54) MEMORY CARD AND MEMORY CARD HOLDING STRUCTURE

(75) Inventor: JIAN-HUI LI, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/879,030

(22) Filed: Sep. 10, 2010

(30) Foreign Application Priority Data
May 27, 2010 (CN) 201020205680.8

(51) Int. Cl. H01R 12/00; H01R 12/16

(52) U.S. Cl. 439/74; 361/785

(57) ABSTRACT

A memory card includes a first memory unit and the second memory unit. The first memory unit and the second memory unit are detachably connected together and are capable of storing and transmitting data, and are capable of working independently. A memory card holding structure using the memory card is also described. The first memory unit and the second memory unit are detachably incorporated together and electrically connected to the connector. Thus, each memory unit can be respectively detached and replaced, which does not affect normal operation of other memory unit. Moreover, the memory cards have two or more memory chip card functions.

### BACKGROUND

1. Technical field

The disclosure generally relates to memory cards, and more particularly, relates to a detachable memory card and a related memory card holding structure.

2. Description of the Related Art

Generally, memory cards, such as subscriber identity module (SIM) cards and trans flash (TF) cards, are widely used with personal digital assistants (PDAs), mobile phones or other electronic devices. Each memory card needs a connector to electrically connect with the electronic devices.

However, varied connectors applied to the electronic device need to arrange corresponding connector circuits on a circuit board, which may increase the size of the circuit board. Moreover, different connectors need to arrange corresponding connector grooves in a housing, which may decrease structural strength of the housing.

Therefore, there is room for improvement within the art.

### BRIEF DESCRIPTION OF THE DRAWINGS

Many aspects of an exemplary memory card and a memory card holding structure can be better understood with reference to the following drawings. The components in the drawings are not necessarily drawn to scale, the emphasis instead being placed upon clearly illustrating the principles of the exemplary memory card and the memory card holding structure. Moreover, in the drawings, like reference numerals designate corresponding parts throughout the several views. Wherever possible, the same reference numbers are used throughout the drawings to refer to the same or like elements of an embodiment.

FIG. 1 is an exploded view of a memory card holding structure including a memory card and a connector, according to an exemplary embodiment.

FIG. 2 is similar to FIG. 1, but viewed from another aspect.

FIG. 3 is an assembled view of the memory card holding structure shown in FIG. 1.

FIG. 4 is similar to FIG. 3, but shown from another aspect.

### DETAILED DESCRIPTION

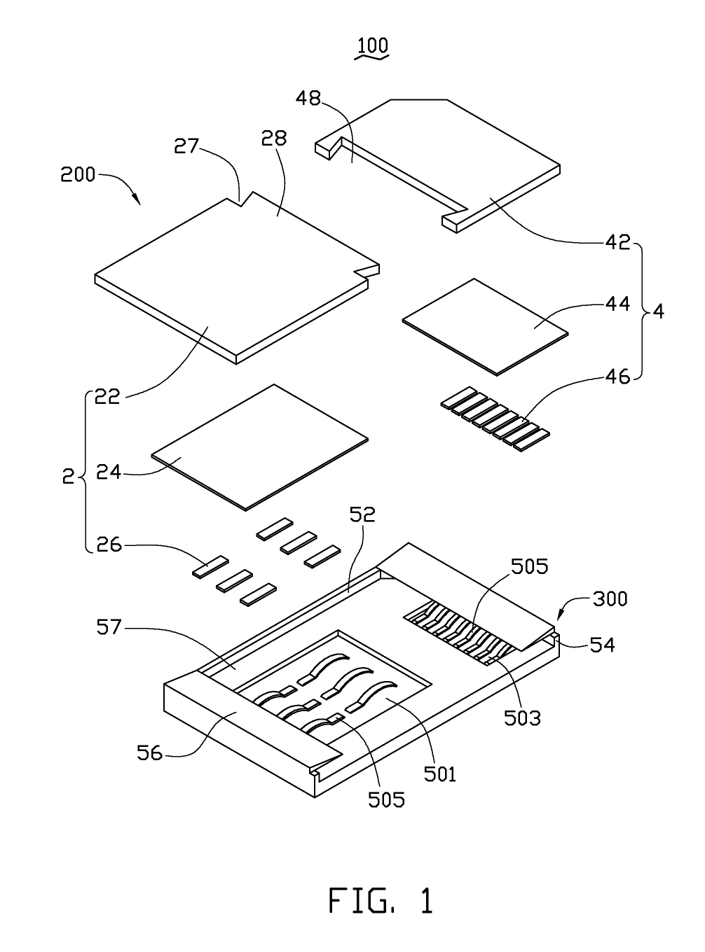

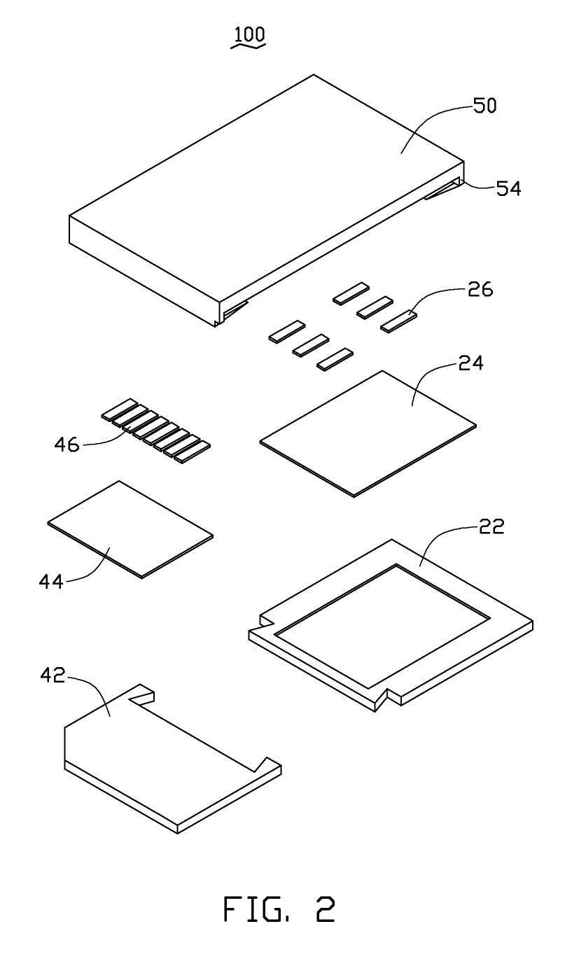

FIGS. 1 and 2 show an exemplary embodiment of a memory card holding structure 100 used with an electronic device. The memory card holding structure 100 includes a memory card 200 and a connector 300 for receiving the memory card 200. The connector 300 is removably mounted within and electrically connected to the electronic device. The memory card 200 is electrically connected to the electronic device through the connector 300. The memory card 200 includes a first memory unit 2 and a second memory unit 4. The first memory unit 2 and the second memory unit 4 are detachably assembled as a whole, so any of them can be easily removed or replaced.

The first memory unit 2 can be a normal SIM card and includes a first base body 22, a first memory chip 24, and a plurality of pins 26. The first base body 22 is a substantially rectangular sheet and can be made of plastics or other insulating materials. The first base body 22 defines two openings 27 at the same end of the first base body 22 and is opened at the corner of the first base body 22. The angle of each opening 27 is less than 90 degree; therefore a locking section 28 is formed at an end of the first base body 22. The locking section 28 is a substantially isosceles trapezoid sheet.

The first memory chip 24 can be detachably mounted within the first base body 22 and is capable of storing information such as telephone numbers, messages or other information data. The pins 26 are mounted on and electrically connected to the first memory chip 24. The pins 26 are electrically connected to a circuit board of the electronic device through the connector 300. The first memory unit 2 is electrically connected to the electronic device to transmit and receive different information data.

The second memory unit 4 can be a normal TF card and includes a second base body 42, a second memory chip 44, and a plurality of pins 46. The second base body 42 is a substantially rectangular sheet and may be made from plastics or other insulating materials. The second base body 42 defines a locking opening 48 with a shape substantially matching with the shape of the locking section 28. The locking section 28 is detachably received within the locking opening 48, accordingly the first memory unit 2 can be detachably assembled to the second memory unit 4 together.

The second memory chip 44 can be detachably mounted within the second base body 42 and is capable of storing information such as images, audio, games or other information data. The pins 46 are mounted on and electrically connected to the second memory chip 44. The pins 46 are electrically connected to the circuit board of the electronic device through the connector 300, therefore the second memory unit 4 is electrically connected to the electronic device to transmit and receive different information data without the interferences of the first memory unit 2.

The connector 300 includes a main body 50, a sidewall 52, two end walls 54, and two resisting sections 56. The main body 50 is a substantially rectangular sheet and defines a first groove 501 and a second groove 503. The shape and the size of the first groove 501 is substantially same with the first memory unit 2. The shape and the size of the second groove 503 are substantially same with the second memory unit 4. Thus, the first memory unit 2 and the second memory unit 4 can be partially or fully received within the first groove 501 and the second groove 503, respectively. Elastic sections 505 are mounted on the bottom of the first groove 501 and the second groove 503. The elastic sections 505 are made from copper, stainless steel or other metal and are electrically connected to the circuit board of the electronic device.

When the first memory unit 2 and the second memory unit 4 are together they are received within the connector 300. The elastic sections 505 elastically resist against and electrically connect the pins 26 and the pins 46 to establish electrical connections between the memory card 200 and the electronic device. The main body 50 may have fourteen elastic sections 505, six elastic sections 505 are mounted in the first groove 501, and others are mounted in the second groove 503.

The two end walls 54 are perpendicularly connected to opposite ends of both sidewalls 52, and the end walls 54 are perpendicular to the surface of the main body 50. The resisting sections 56 are perpendicularly connected to the corresponding end walls 54 and are parallel to the main body 50, resulting in forming a receiving space 57. The distance between the resisting sections 56 and the main body 50 is substantially equal to or larger than the thickness of the first memory unit 2 and the second memory unit 4. The receiving space 57 is capable of receiving the memory card 200 or other chip cards with an identical shape and size as the memory card 200.

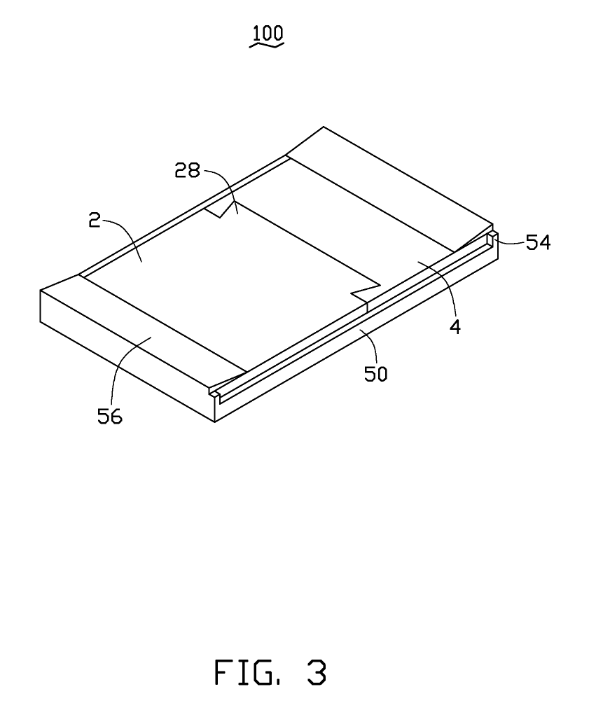

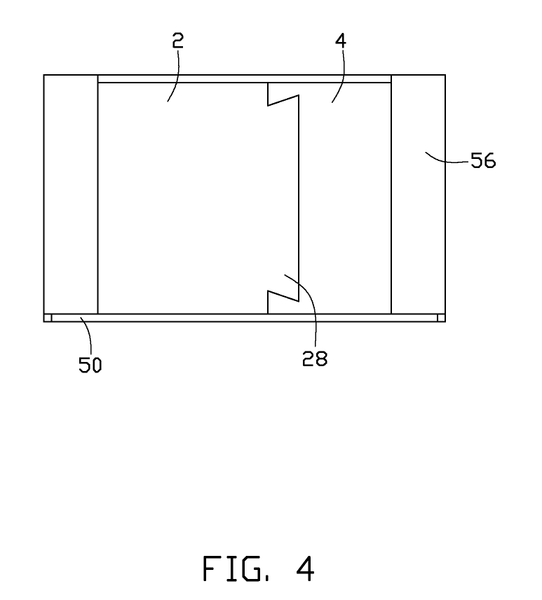

Referring further to FIGS. 3 and 4, to assemble the memory card 200 to the connector 300, the locking section 28 is aligned with and is received within the locking opening 48 of the second memory unit 4, accordingly, the first memory unit 2 and the second memory unit 4 are separably connected. The first memory chip 24 and the second memory chip 44 are aligned with the first groove 501 and the second groove 503, respectively. The first memory unit 2 and the second memory unit 4 are incorporated and are inserted within the receiving space 57. The first memory unit 2 and the second memory unit 4 resist against the two resisting sections 56, and are partially expose from the receiving space 57. The elastic sections 505 of the first groove 501 elastically resist against and electrically connect the pins 26, and the elastic sections 505 of the second groove 503 elastically resist against and the electrically connect the pins 46 of the second memory unit 4. Thus, the memory card 200 is received within the connector 300 and is electrically connected to the electronic device.

To remove the first memory unit 2 or the second memory unit 4 from the connector 300, the first memory unit 2 is detached relative to the second memory unit 4. If one of the first memory unit 2 or the second memory unit 4 is removed from the receiving space 57, the memory unit within the receiving space 57 is held against the resisting section 56 and maintains a normal operational state. For example, when the first memory unit 2 is removed from the receiving space 57, the second memory unit 4 remains within the receiving space 57 and is held between the resisting section 56 and the bottom of the main body 50 (in the resisting section 56). Since the first memory unit 2 and the second memory unit 4 are electrically connected to different circuits, the second memory unit 4 maintains normal operation.

In addition, both the first memory chip 24 and the second memory chip 44 have ground pins. The ground pins of both the first memory chip 24 and the memory chip 44 can share with a same ground port to electrically connect to the circuit board. The first memory unit 2 can be compatible with the second memory unit 4, and the first memory chip 24 and the second memory chip 44 maintain the original size and pin arrangement.

Alternatively, the first memory unit 2 and the second memory unit 4 can be further connected by a shaft (not shown). The first memory unit 2 and the second unit 4 define through holes, respectively, and the shaft is passed through the through holes. The first memory unit 2 is rotatably and detachably connected relative to the second memory unit 4. Thus, the first memory unit 2 can be detached from the second memory unit 4 if removing the shaft from the through holes.

Alternatively, the memory card 200 can further include memory units detachably connected. Accordingly, the connector 300 can further define a plurality of grooves for receiving the memory units, and each memory chip corresponds to elastic sections 505. Alternatively, the grooves can be omitted, and the elastic sections 505 are directly positioned on the surface of the main body 50 of the connector 300.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A memory card, comprising:
a first memory unit for storing and transmitting information data; and
a second memory unit for storing and transmitting information data, wherein the first memory unit and the second memory unit are detachably connected together and are capable of working independently.

2. The memory card as claimed in claim 1, wherein the first memory unit comprises a first base body, the first base body comprises a locking section at an end of the first base body, and the second memory unit comprises a second base body, the second base body defines a locking opening, the locking section is detachably received within the locking opening to detachably connect the first memory unit to the second memory unit.

3. The memory card as claimed in claim 2, wherein the first memory unit further comprises a first memory chip, the second memory unit further comprises a second memory chip, and the first memory chip and the second memory chip are respectively mounted within the first base body and the second base body and are capable of storing information data.

4. The memory card as claimed in claim 3, wherein the first memory unit further comprises pins mounted on the first memory chip, the second memory unit further comprises pins mounted on the second memory chip, and the first memory chip and the second memory chip are electrically connected to a connector through the pin to transmit information data.

5. The memory card as claimed in claim 4, wherein the ground pins of the first memory chip and the second memory chip are interconnected to each other and share a ground port to connect the ground.

6. The memory card as claimed in claim 1, further comprising memory units, wherein the memory units are detachably connected together, and each memory unit is capable of being respectively detached and replaced and working independently.

7. A memory card holding structure, comprising:
a memory card comprising a first memory unit and a second memory unit for storing and transmitting information data; and
a connector electrically connected to the first memory unit and the second memory unit, the connector defining a receiving space, wherein the connector comprises two groups of elastic sections, the first memory unit and the second memory unit are detachably connected as a whole and are releasably received within the receiving space, and the first memory unit is electrically connected to a group of elastic sections, the second memory unit is electrically connected to another group of elastic sections.

8. The memory card holding structure as claimed in claim 7, wherein the first memory unit comprises a first base body, the first base body comprises a locking section located at an end of the first base body, the second memory unit comprises a second base body, the second base body defines a locking opening, and the locking section is detachably received within the locking opening to detachably connect the first memory unit to the second memory unit.

9. The memory card holding structure as claimed in claim 8, wherein the first memory unit further comprises a first memory chip, the second memory unit further comprises a second memory chip, and the first memory chip and the second memory chip are respectively mounted within the first base body and the second base body and are capable of storing and transmitting information data.

10. The memory card holding structure as claimed in claim 9, wherein the first memory unit further comprises pins mounted on the first memory chip, the second memory unit further comprises pins mounted on the second memory chip, and the first memory chip and the second memory chip are electrically connected to the connector through the pin to transmit information data.

11. The memory card holding structure as claimed in claim 10, wherein the connector further comprises a main body, the main body defines a first groove and a second groove, the first groove and the second groove are capable of respectively receiving the first memory chip and the second memory chip, and the two groups of elastic sections are mounted on the bottom of the first groove and the second groove to resist against and electrically connect the pins.

12. The memory card holding structure as claimed in claim 11, wherein the connector further comprises a sidewall and two end walls perpendicularly connected to opposite ends of the sidewall, and the sidewall and the two end walls are perpendicularly connected to the main body.

13. The memory card holding structure as claimed in claim 12, wherein the connector further comprises two resisting sections, the resisting sections are perpendicularly connected to the corresponding end walls and are parallel to the main body to form the receiving space, and the resisting sections are capable of resisting against the first memory unit and the second memory unit.

14. The memory card holding structure as claimed in claim 13, wherein the distance between the resisting sections and the main body is substantially equal to or larger than the thickness of the first memory unit and the second memory unit to resist against and hold the first memory unit and the second memory unit.

15. The memory card holding structure as claimed in claim 10, wherein the connector further comprises a main body, and the two groups of elastic sections are mounted on the surface of the main body to resist against and electrically connect the pins.

16. The memory card holding structure as claimed in claim 7, wherein the memory card further comprises memory units detachably connected together and releasably received within the receiving space, and each memory unit is capable of being respectively detached and replaced and working independently.

17. The memory card holding structure as claimed in claim 16, wherein the connector further comprises groups of elastic sections, and each memory unit is electrically connected and corresponds to a group of elastic sections.

18. The memory card holding structure as claimed in claim 10, wherein the ground pins of the first memory chip and the second memory chip are interconnected to each other and share a ground port to connect the ground.
